(19) United States
(12) Patent Application Publication
(10) Pub. No.: US 2005/0256641 A1
(43) Pub. Date: Nov. 17, 2005

(54) System and method for dynamic alternative route geographic plotting

(76) Inventors: Jeffrey D. Ollis, Dresher, PA (US); David T. Horoschak, Doylestown, PA (US); Thomas L. Du Breuil, Ivyland, PA (US)

Correspondence Address: GENERAL INSTRUMENT CORPORATION, 101 Tournament Drive, Horsham, PA, 19044, US

(21) Appl. No.: 10/808,892

(22) Filed: Mar. 25, 2004

(51) Int. Cl. G01C 21/34

(52) U.S. Cl. 701/213; 701/210; 340/995.19

(57) ABSTRACT

A system and method for dynamic alternative geographic route plotting using global positional satellite data is disclosed. The present system and method provide for using a voice selection/recognition engine to extract information relating anomalous conditions from radio broadcasts in the primary band of broadcast radio. The anomalous conditions are then sent to a GPS device which dynamically provide alternative routes. Further, the present system and method also provide for receiving information relating to anomalous conditions via the sub-band of broadcast radio. Anomalous conditions received via the sub-band are also sent to a GPS device which dynamically provide alternative routes.

### FIELD OF THE INVENTION

The present invention relates to global positional satellite systems. More specifically, the present invention relates to providing dynamic alternative route information in response to current negative road conditions or other anomalies.

### BACKGROUND OF THE INVENTION

With the advent of global positional satellite (“GPS”) systems, many automobile drivers have incorporated GPS devices into their vehicles. Such GPS devices may be an integral part of an automobile, purchased as an “add-on”, or in many instances consumers use portable GPS devices, suitable for any portable use, e.g., for camping, hiking, in their vehicles, etc.

Using the above described GPS devices, such devices conventionally continually query a satellite(s) for its global position. A user of a GPS in a moving vehicle typically enters their desired designation into the GPS. Through the use of road databases, the desired designation data, and current geographic positional data, the GPS will guide the user along a static travel route, via a text, graphics and/or audio output.

In conjunction with GPS devices, many drivers conventionally listen to traffic and weather reports on traditional broadcast radio (“TBR”) via an audio tuner, found in nearly every vehicle. These TBRs are helpful for drivers to pinpoint anomalies such as accidents, unusual traffic congestion, and/or weather related problems. (TBR as used herein excludes digital audio broadcast services, such as XM RADIO.)

In instances of an anomaly, a traditional GPS device is somewhat useless. If the driver knows the geographic area, the driver can enter a new destination. But then again, if the driver knew the area, they would not likely be using a GPS device in the first instance. Thus, the practical result is the GPS device becomes quite useless when an anomalous condition exists in the path of the normal static travel route the GPS device would normally give to a driver.

To attempt to counterbalance this shortcoming, a system has been created which combines a GPS with cellular technology. This system, uses cellular based communication to communicate anomalies to the GPS. In turn, the GPS can provide the driver with an alternative route. However, such an infrastructure is costly, as well as the subscription service of each user of such a system.

What is needed is an efficient system to report geographic anomalies to a GPS device for use in providing dynamic alternative routing to an end user. Such a system would ideally not require any additional infrastructure, or expense to the end user.

### SUMMARY OF INVENTION

An object of the present invention is to provide a system and method for dynamic alternative geographic route plotting using global positional satellite data.

In order to achieve this objective, as well as others which will become apparent in the disclosure below, in a first exemplary embodiment the present invention provides for a system including an audio primary band tuner, a GPS device, and a speech recognition engine (“SRE”).

In this first exemplary embodiment of the present invention, the SRE constantly monitors TBR signals via the audio primary band tuner for pre-defined recording triggers (“Record Trigger”), such as voice recognition, signalling tone, or pre-defined time. When a Record Trigger occurs, the SRE begins recording a desired portion of the TBR, at a pre-selected frequency (radio station frequency, e.g. 1010 a.m.) associated with the Record Trigger, to the audio capture memory. The duration of the recording may preferably be a fixed duration, e.g., one minute, or until a pre-defined recording stop trigger (“Stop Trigger”) occurs.

In accordance with this first exemplary embodiment of the present invention, once the desired portion of the TBR signal is recorded (hereinafter referred to as a recorded pre-defined audio broadcast signal (“PABS”)), the SRE translates the PABS to a text string and parses out text relating to an anomaly. This parsed text is then placed in a text string format suitable for upload to the GPS (anomaly text string, “ATS”). The SRE then sends the ATS to the GPS. The GPS receives the ATS and determines whether the ATS is in the route of previously given route directions. If so, the GPS determines an alternative route, and thereafter, notifies the end user of the alternate route. Preferably, the GPS also notifies the end user of the ATS itself, e.g., flood, fire, traffic accident, etc.

A second exemplary embodiment of the present invention provides for a system including an audio sub-band tuner, sub-band converter, and GPS.

In accordance with this second exemplary embodiment of the present invention, radio station broadcasters transmit anomaly information, along with other data, e.g., station identification, via the sub-band in the frequency (sub-band information, “SBI”). Upon receipt of an SBI, the audio sub-band tuner sends the SBI to the sub-band converter. The sub-band converter then translates the SBI into a text string and parses out text relating to an anomaly. This parsed text is convert to an ATS. The sub-band converter then sends the ATS to the GPS. The GPS receives the ATS and determines whether the ATS is in the route of previously given route directions. If so, the GPS determines an alternative route, and thereafter, notifies the end user of the alternate route. Preferably, the GPS also notifies the end user of the ATS itself, e.g., flood, fire, traffic accident, etc.

In yet a third exemplary embodiment in accordance with the present invention, the first and second exemplary embodiments may be implemented together to allow the same system and method to provide dynamic alternative geographic route plotting, by means of global positional satellite data, utilizing the present invention's inventive (i) speech recognition/trigger method of the audio primary band tuner, and/or (2) SBI using the audio sub-band tuner. In this way PABS and SBIs may be used for dynamic alternative route plotting in accordance with the present invention.

Thus, the present system and method provide for dynamic alternative geographic route plotting using global positional satellite data.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of a system for dynamic alternative geographic route plotting using global positional satellite data in accordance with a first exemplary embodiment of the present invention;

FIG. 2 is a flow diagram showing the basic process flow for dynamic alternative geographic route plotting using global positional satellite data in accordance with the first exemplary embodiment of the present invention;

FIG. 3 is an illustration of a system for dynamic alternative geographic route plotting using global positional satellite data in accordance with a second exemplary embodiment of the present invention;

FIG. 4 is a flow diagram showing the basic process flow for dynamic alternative geographic route plotting using global positional satellite data in accordance with the second exemplary embodiment of the present invention;

FIG. 5 is an illustration of a system for dynamic alternative geographic route plotting using global positional satellite data in accordance with a third exemplary embodiment of the present invention; and

FIG. 6 is a flow diagram showing the basic process flow for dynamic alternative geographic route plotting using global positional satellite data in accordance with the third exemplary embodiment of the present invention.

### DESCRIPTION OF A PRESENTLY PREFERRED EMBODIMENT

Referring to FIG. 1, system 100 is shown. System 100 is a system for dynamic alternative geographic route plotting using global positional satellite data in accordance with a first exemplary embodiment of the present invention. System 100 includes an audio primary band tuner 102, a SRE 106, an audio capture memory 104, GPS device 110, and display 112.

In accordance with this first exemplary embodiment of the present invention, audio primary band tuner 102 is a frequency tuner used to receive modulated radio frequency (“RF”) signals in the primary band of broadcast radio. SRE 106 manages the recording of pre-defined TBR signals for use in anomaly information extraction, as described in detail below. SRE 106 preferably includes speech (voice) recognition abilities, as well as signal frequency detection, e.g., the ability to distinguish between a 1.2 KHz tone and a 800 Hz tone, for example. Speech recognition and signal frequency detection systems and methods are well known in the art. The audio capture memory 104 may be random access memory, flash memory, a hard drive, optical drive, or optical-magnetic drive. Audio capture memory 104 temporarily stores TBR signals recorded by SRE 106 (resulting in PABS(s)). The GPS 110 is used to provide an end user with local maps, or to determine a travel route between an end user's current location (or starting point) and a desired end location/destination point. The GPS 110 of the present invention also provides an alternative route in an instance where the information contained in the PABS relates to an anomaly, such as traffic accidents, unusual traffic congestion, natural disaster, and/or weather related problems. Upon receiving information of an anomaly, the GPS 110 provides the end user with an alternative route, to obviate a recent prior instance of a route given by the GPS 110, such that the end user may avoid the anomaly. In addition to providing an alternative route, the GPS 110 may also provide a map of the area where the anomaly occurred. Display 112 is a conventional data display used by the GPS 110, SRE 106, and/or audio primary band tuner 102 to display various status messages to the user, including text, the existence of an anomaly, and/or graphical geographic illustrations, e.g., maps. Display 112 may also include a user interface for programming which TBR portions to record (described below) or the Trigger.

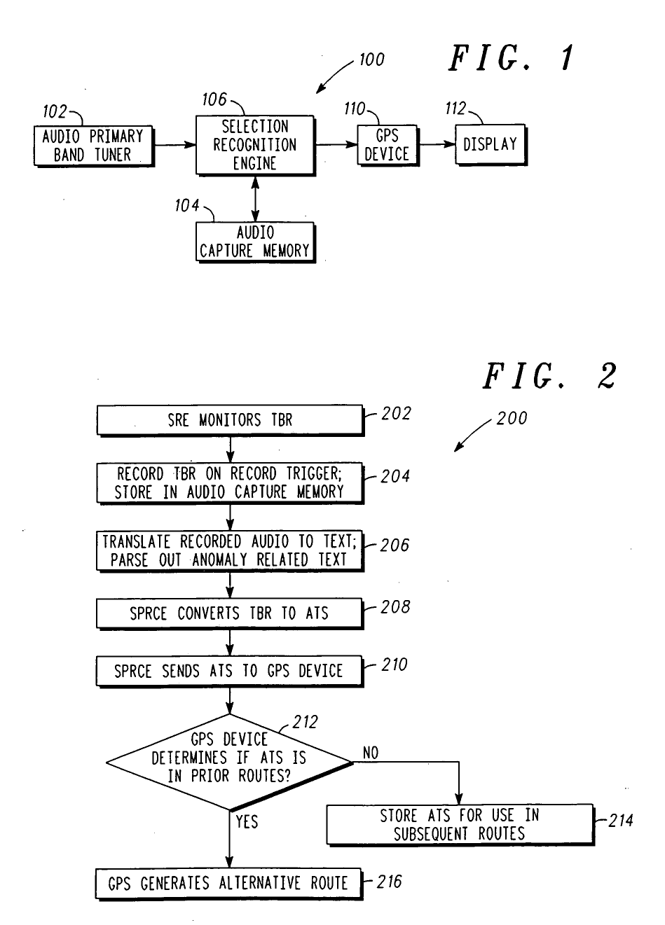

Referring to FIG. 2, in operation, in accordance with this first exemplary embodiment of the present invention, the SRE 106 constantly monitors TBR signals via the audio primary band tuner 102 for a Record Trigger, such as voice recognition, signalling tone, or pre-defined time, in step 202. Recording Triggers may be pre-defined by the user in the SRE 106, and/or be pre-programmed into the SRE 106 based upon conventional or standardized TBR tones or events. For example, a 1.2 KHz tone may be conventionally known to be the prefix to a weather report. Further, audio primary band tuner 102 preferably may receive multiple RF frequencies (multi-band tuner), so as to allow the SRE 106 to monitor multiple TBR signals (stations) simultaneously.

When a Record Trigger occurs, the SRE 106 begins recording a desired duration of the TBR, at the pre-selected frequency associated with the Record Trigger, to the audio capture memory 104, in step 204. The recording may preferably be in the form of MP3 audio, MPEP4 audio, or AC-3 audio format, for example. The duration of the recording may preferably be a fixed duration, e.g., one minute, or until a Stop Trigger occurs. A Stop Trigger may be a change in orators voice, where speech recognition is the Record Trigger; or a conventional or standardized TBR tone or event, for example, a 800 Hz tone may be conventionally known to be the suffix to a weather report.

Please note, the present invention is described with reference to a single PABS solely for easy of explanation. It should be understood that system 100 may handle multiple PABS signals.

In accordance with this first exemplary embodiment of the present invention, once the desired portion of the TBR signal is recorded (PABS), the SRE 106 translates the PABS to a text string and parses out text relating to an anomaly, in step 206. The SRE 106 then converts the parsed text into an ATS (format suitable for GPS 110), in step 208. The SRE 106 then sends the ATS to the GPS 110, in step 210. The GPS 110 takes the ATS and determines whether the ATS is within the route of a prior route already communicated to the end user, in step 212. The “prior route” analysis is preferably limited to a pre-determined time frame, e.g., route results given over the last 24 hours, for example. If the ATS is within the path of a prior route, the GPS 110 determines an alternative route and communicates the alternative route to the end user, preferably, via the display 112, in step 216. However, such alternative route can also be communicated audibly. If the ATS is not within the path of a prior route (as described above), the GPS 110 stores the ATS for a pre-determined time out period, in step 214. Any future route request in the path of said ATS, before the time out period, will take the ATS into account and provide a route avoiding the ATS. In addition to providing an alternative route, upon receipt of the ATS, the GPS 110 may provide a map of the area where the anomaly occurred.

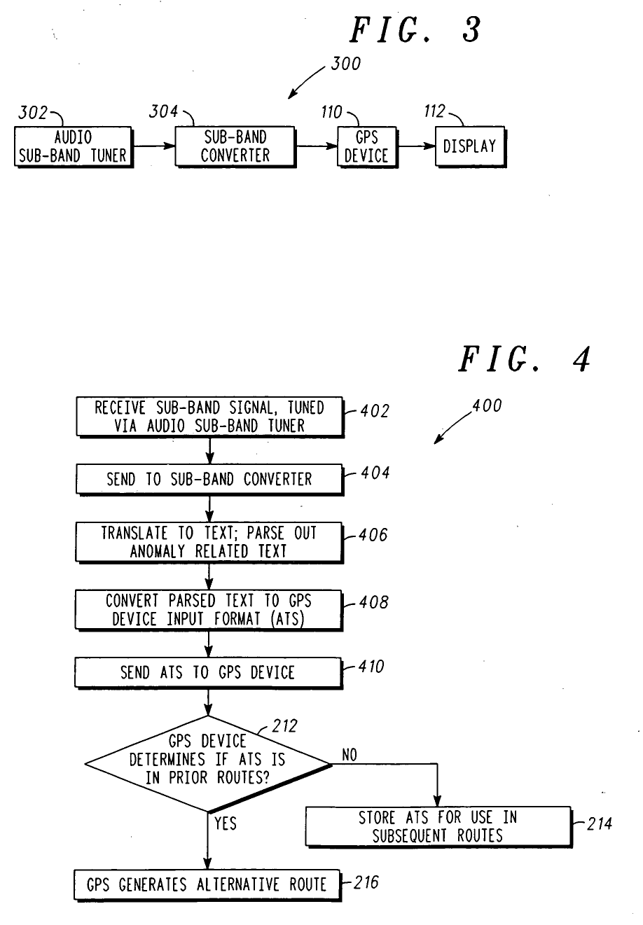

Referring to FIG. 3, in accordance with a second exemplary embodiment of the present invention, system 200 is shown. System 200 includes an audio sub-band tuner 302, a sub-band converter 304, GPS 110, and display 112. Audio sub-band tuner 302 is a frequency tuner used to receive modulated radio frequency (“RF”) signals in the sub-band of TBR. The sub-band is conventionally used to transmit the station identification, e.g., WABC. This sub-band information can be seen on the display screen in car radios of most modern automobiles. However, to date, station identification data is the only data known to be communicated in the sub-band.

Referring to FIG. 4, in operation, the audio sub-band tuner 302 receives SBI signals on one or more frequencies it is tuning, in step 402. The frequencies being tuned by the audio sub-band tuner 302 may be pre-defined. The audio sub-band tuner 302 sends all received SBIs to the sub-band converter 304, in step 404. Then the sub-band converter 304 translates the SBIs into text and parses the SBIs for data relating to an anomaly, in step 406. The sub-band converter 304 then converts the parsed text into an ATS (format suitable for GPS 110), in step 408. The sub-band converter 304 then sends the ATS to the GPS 110, in step 410. Then, identical to the first exemplary embodiment, the GPS 110 takes the ATS and determines whether the ATS is within the route of a prior route already communicated to the end user, in step 212. The “prior route” analysis is preferably limited to a pre-determined time frame, e.g., route results given over the last 24 hours, for example. If the ATS is within the path of a prior route, the GPS 110 determines an alternative route and communicates the alternative route to the end user, preferably, via the display 112, in step 216. However, such alternative route can also be communicated audibly. If the ATS is not within the path of a prior route (as described above), the GPS 110 stores the ATS for a pre-determined time out period, in step 214. Any future route request in the path of said ATS, before the time out period, will take the ATS into account and provide a route avoiding the ATS. In addition to providing an alternative route, upon receipt of the ATS, the GPS 110 may provide a map of the area where the anomaly occurred.

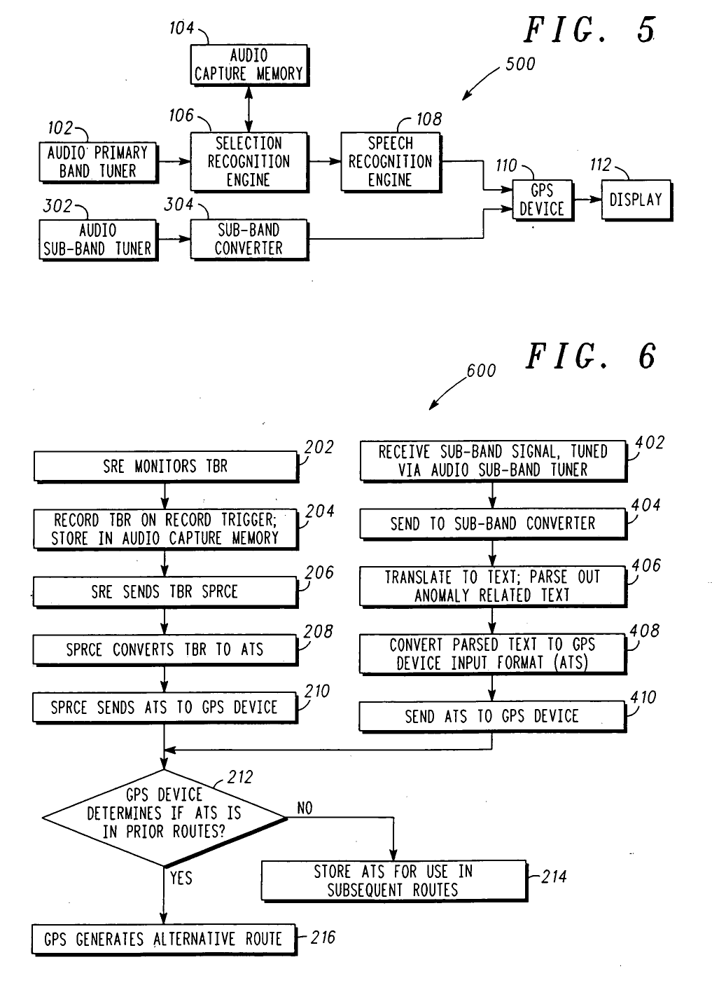

Referring to FIGS. 5 and 6, in yet a third exemplary embodiment in accordance with the present invention, the first and second exemplary embodiments may be implemented together to allow the same system and method to provide dynamic alternative geographic route plotting, by means of global positional satellite data, utilizing the inventive (i) speech recognition/trigger method of the audio primary band tuner, and/or (2) SBI using the audio sub-band tuner. In this way PABS and SBIs may be used for dynamic alternative route plotting in accordance with the present invention. This third exemplary embodiment is clearly illustrated in the system diagram of FIG. 5 and process flow diagram of FIG. 6. In this way PABS and SBIs may be used for dynamic alternative route plotting in accordance with the present invention.

Alternatively and/or in addition to the above described exemplary embodiments, a PABS (in the primary band) can embody coordinate (x, y) data, for example interspersed in a series of tones. In such an instance, the coordinate data would be translated to an ATS by the SRE 106, and sent to the GPS 110. Further, if using a digital radio broadcast, ATSs can be natively sent by the digital audio broadcasters for receipt by the GPS 110.

Thus, the present system and method provides for dynamic alternative geographic route plotting using global positional satellite data.

Although the invention has been described herein by reference to an exemplary embodiment thereof, it will be understood that such embodiment is susceptible of modification and variation without departing from the inventive concepts disclosed. For example, the SRE 106 and sub-band converter 304 may be integrated as a single component. Similarly, one audio tuner component, tuning both the primary and sub-band frequencies, may be used. In addition, the above system and method may be used in a stationary location, e.g., a home, camp site. All such modifications and variations, therefore, are intended to be encompassed within the spirit and scope of the appended claims.

1. A system for dynamic alternative geographic route plotting using global positional satellite data, said system comprising:
an audio tuner, said audio tuner tuning frequencies for reception of radio broadcast signals;
a selection recognition engine coupled to said audio tuner, said selection recognition engine monitoring said radio broadcast signals for pre-defined recording triggers and selectively recording portions of a radio broadcast signal, said selection recognition engine extracting anomaly information from said recorded portions; and
a global positional satellite device, said global positional satellite device receiving said anomaly information and generating at least one alternative route in response to said anomaly information.

2. The system of claim 1 further comprising an audio capture memory coupled to said selection recognition engine, said audio capture memory storing recorded portions of said radio broadcast signal.

3. The system of claim 2, wherein said audio capture memory comprises at least one of random access memory, flash memory, a hard drive, optical drive, and optical-magnetic drive.

4. The system of claim 1 wherein said radio broadcast signal comprises a primary band signal.

5. The system of claim 1 further comprising a display.

6. A method for dynamic alternative geographic route plotting using global positional satellite data, said method comprising the steps of:
monitoring radio broadcast signals for a pre-defined recording trigger;
recording at least a portion of a radio broadcast signal upon an occurrence of said recording trigger at a pre-selected frequency associated with said record trigger;
sending anomaly information in said recording to a global positional satellite device.

7. The method of claim 6 further comprising the step of said global positional satellite device generating an alternate route in response to said anomaly information.

8. The method of claim 6 further comprising the step of displaying a map of the locality of a geographic area identified in said anomaly information.

9. The method of claim 6, wherein said record trigger comprises at least one of voice recognition, signalling tone, and pre-defined time.

10. The method of claim 6, where said recording comprising digitally compressing said recorded portion of said radio broadcast signal in at least one of MP3 audio, MPEP4 audio, and AC-3 audio format.

11. The method of claim 6 further comprising a stop trigger, stop trigger comprising at least one of a fixed time after said start of said step of recording, a pre-defined recording stop time, voice recognition, change in an orators voice, a standardized tone, and standardized event.

12. The method of claim 6 further comprising the step of notifying when said anomaly information is received.

13. A system for dynamic alternative geographic route plotting using global positional satellite data, said system comprising:
an audio tuner, said audio tuner tuning frequencies for reception of sub-band radio broadcast signals; and
a global positional satellite device, said global positional satellite device receiving anomaly information contained in said sub-band radio broadcast signals and generating at least one alternative route in response to said anomaly information.

14. The system of claim 13 further comprising a sub-band converter, said sub-band converter receiving said sub-band radio broadcast signals and extracting said anomaly information.

15. A method for dynamic alternative geographic route plotting using global positional satellite data, said method comprising the steps of:
receiving sub-band broadcast signals; and
sending said sub-band broadcast to a global positional satellite device.

16. The method of claim 15 further comprising the step of said global positional satellite device generating an alternate route in response to said sub-band broadcast signals.

17. The method of claim 15 further comprising the step of displaying a map of the locality of a geographic area identified in said sub-band broadcast signals.

18. The method of claim 15 further comprising the step of extracting anomaly information from said sub-band broadcast signals, after receiving said sub-band broadcast signals.

19. The method of claim 18 further comprising the step of said global positional satellite device generating an alternate route in response to said anomaly information.

20. The method of claim 18 further comprising the step of displaying a map of the locality of a geographic area identified in said anomaly information.

21. The method of claim 18 further comprising the step of notifying when said anomaly information is received.
